(19) United States
(12) Patent Application Publication
(10) Pub. No.: US 2023/0162437 A1
(43) Pub. Date: May 25, 2023

(54) IMAGE PROCESSING DEVICE, CALIBRATION BOARD, AND METHOD FOR GENERATING 3D MODEL DATA

(71) Applicant: SONY GROUP CORPORATION, TOKYO (JP)

(72) Inventor: KIYOMI ITO, TOKYO (JP)

(21) Appl. No.: 17/995,640

(22) PCT Filed: Mar. 31, 2021
(86) PCT No.: PCT/JP2021/013910

§ 371 Date: Oct. 6, 2022

(30) Foreign Application Priority Data
Apr. 14, 2020 (JP) 2020-072327

(51) Int. Cl. G06T 17/00; G06T 7/80; G06V 10/141; H04N 5/04; H04N 13/279

(52) U.S. Cl. CPC G06T 17/00; G06T 7/80; G06V 10/141; H04N 5/04; H04N 13/279

(57) ABSTRACT

The present technique relates to an image processing device, a calibration board, and a method for generating 3D model data, which can easily achieve synchronization among devices. An image processing device including; an image synchronization unit that performs time synchronization on a plurality of images of a board on a basis of lighting conditions of a plurality of light-emitting parts included in the plurality of images captured by a plurality of imaging devices, the board including the plurality of light-emitting parts and a predetermined image pattern; and a calibration unit that calculates camera parameters of the plurality of imaging devices by using the plurality of images having been subjected to the time synchronization. The present technique can be applied to, for example, an image processing system that captures images to generate a 3D model.

### TECHNICAL FIELD

The present technique relates to an image processing device, a calibration board, and a method for generating 3D model data and particularly relates to an image processing device, a calibration board, and a method for generating 3D model data, by which synchronization among devices can be easily achieved.

### BACKGROUND ART

A technique is available to provide a free viewpoint image by generating a 3D model of a subject from moving images captured from multiple viewpoints and generating a virtual viewpoint image of the 3D model according to any viewing position. This technique is also called volumetric capture.

A plurality of imaging devices for capturing moving images for generating a 3D model are disposed at different locations to capture a subject from different directions (viewpoints), and the positional relationship among the imaging devices is calculated. The calculation of the positional relationship among the imaging devices requires the use of moving images synchronized among the imaging devices.

Various techniques have been proposed for the calibration of imaging devices (for example, see PTL 1 and PTL 2).

### CITATION LIST

### Patent Literature

[PTL 1]
JP 2018-111166A
[PTL 2]
JP 2007-129709A

### SUMMARY

### Technical Problem

However, a method for synchronization among a plurality of imaging devices is not disclosed.

The present technique has been made in view of such a situation and is configured to easily achieve synchronization among devices.

### Solution to Problem

An image processing device according to a first aspect of the present technique includes: an image synchronization unit that performs time synchronization on a plurality of images of a board on a basis of lighting conditions of a plurality of light-emitting parts included in the plurality of images captured by a plurality of imaging devices, the board including the plurality of light-emitting parts and a predetermined image pattern; and a calibration unit that calculates camera parameters of the plurality of imaging devices by using the plurality of images having been subjected to the time synchronization.

In the first aspect of the present technique, time synchronization is performed on a plurality of images of a board on a basis of lighting conditions of a plurality of light-emitting parts included in the plurality of images captured by a plurality of imaging devices, the board including the plurality of light-emitting parts and a predetermined image pattern, and the camera parameters of the plurality of imaging devices are calculated by using the plurality of images having been subjected to the time synchronization.

A calibration board according to a second aspect of the present technique includes a plurality of light-emitting parts that change lighting conditions at each lapse of a unit time, and a predetermined image pattern, wherein the plurality of light-emitting parts are caused to illuminate to perform time synchronization on a plurality of images captured by a plurality of imaging devices.

Provided in the second aspect of the present technique are a plurality of light-emitting parts that change lighting conditions at each lapse of a unit time and a predetermined image pattern. The plurality of light-emitting parts are caused to illuminate to perform time synchronization on a plurality of images captured by a plurality of imaging devices.

A method for generating 3D model data according to a third aspect of the present technique, the method including: performing time synchronization on a plurality of images of a board on a basis of lighting conditions of a plurality of light-emitting parts included in the plurality of images captured by a plurality of imaging devices, the board including the plurality of light-emitting parts and a predetermined image pattern; calculating camera parameters of the plurality of imaging devices by using the plurality of images having been subjected to the time synchronization; generating a 3D model of a predetermined subject from a plurality of subject images of the predetermined subject, the subject images being captured by the plurality of imaging device by using the calculated camera parameters; and generating a virtual viewpoint image by viewing the generated 3D model of the predetermined subject from a predetermined viewpoint.

In the third aspect of the present technique, time synchronization is performed on a plurality of images of a board on a basis of lighting conditions of a plurality of light-emitting parts included in the plurality of images captured by a plurality of imaging devices, the board including the plurality of light-emitting parts and a predetermined image pattern; the camera parameters of the plurality of imaging devices are calculated by using the plurality of images having been subjected to the time synchronization; a 3D model of a predetermined subject is generated from a plurality of subject images of the predetermined subject, the subject images being captured by the plurality of imaging device by using the calculated camera parameters; and a virtual viewpoint image is generated by viewing the generated 3D model of the predetermined subject from a predetermined viewpoint.

The image processing device according to a first aspect of the present technique can be realized by causing a computer to execute a program. The program to be executed by the computer can be provided by transmission through a transmission medium or recording on a recording medium.

The image processing device may be a standalone device or an internal block constituting one device.

### BRIEF DESCRIPTION OF DRAWINGS

FIG. 1 is an explanatory drawing of the generation of a 3D model of a subject and the display of a free viewpoint image.

FIG. 2 is a block diagram illustrating a configuration example of an image processing system to which the present technique is applied.

FIG. 3 is an explanatory drawing of the synchronization of moving images.

FIG. 4 is a diagram illustrating an example of a calibration board.

FIG. 5 is a diagram illustrating a lighting example of the light-emitting parts of the calibration board.

FIG. 6 is an explanatory drawing illustrating a method of using the time display part of the calibration board.

FIG. 7 is an explanatory drawing illustrating a method of using the position display part of the calibration board.

FIG. 8 is an explanatory drawing illustrating a method of using the position display part of the calibration board.

FIG. 9 is an explanatory drawing illustrating the calibration of cameras with the calibration board.

FIG. 10 is an explanatory drawing illustrating the calibration of cameras with the calibration board.

FIG. 11 is a block diagram illustrating a configuration example of the calibration board.

FIG. 12 is a block diagram illustrating a configuration example of an image processing device.

FIG. 13 is a flowchart for explaining the position pattern assignment of the calibration board.

FIG. 14 is a flowchart for explaining the time information lighting of the calibration board.

FIG. 15 is a flowchart for explaining the position information lighting of the calibration board.

FIG. 16 is a flowchart for explaining the image extraction of the image processing device.

FIG. 17 is a flowchart for explaining the calibration of the image processing device.

FIG. 18 is a diagram illustrating a modification example of the calibration board.

FIG. 19 is a block diagram illustrating a configuration example of the image processing device for generating a 3D model.

FIG. 20 is a flowchart for explaining 3D model generation.

FIG. 21 is a block diagram illustrating a configuration example of an embodiment of a computer to which the present technique is applied.

### DESCRIPTION OF EMBODIMENTS

A mode for embodying the present disclosure (hereinafter referred to as an embodiment) will be described below with reference to the accompanying drawings. In the present specification and the drawings, components having substantially the same functional configuration will be denoted by the same reference numerals, and thus repeated descriptions thereof will be omitted. The description will be given in the following order.

1. Outline of volumetric capture
2. Configuration example of image processing system
3. Calibration using calibration board
4. Block diagram
5. Position pattern assignment
6. Time information lighting
7. Position information lighting
8. Image extraction

### 9. Calibration

10. Modification example of calibration board
11. Configuration example of 3D model generation
12. Flowchart of 3D model generation
13. Computer configuration example

<1. Outline of Volumetric Capture>

An image processing system according to the present disclosure relates to volumetric capture for providing an image with a free viewpoint (free viewpoint image) by generating a 3D model of a subject from images captured from multiple viewpoints and generating a virtual viewpoint image of the 3D model according to any viewing position.

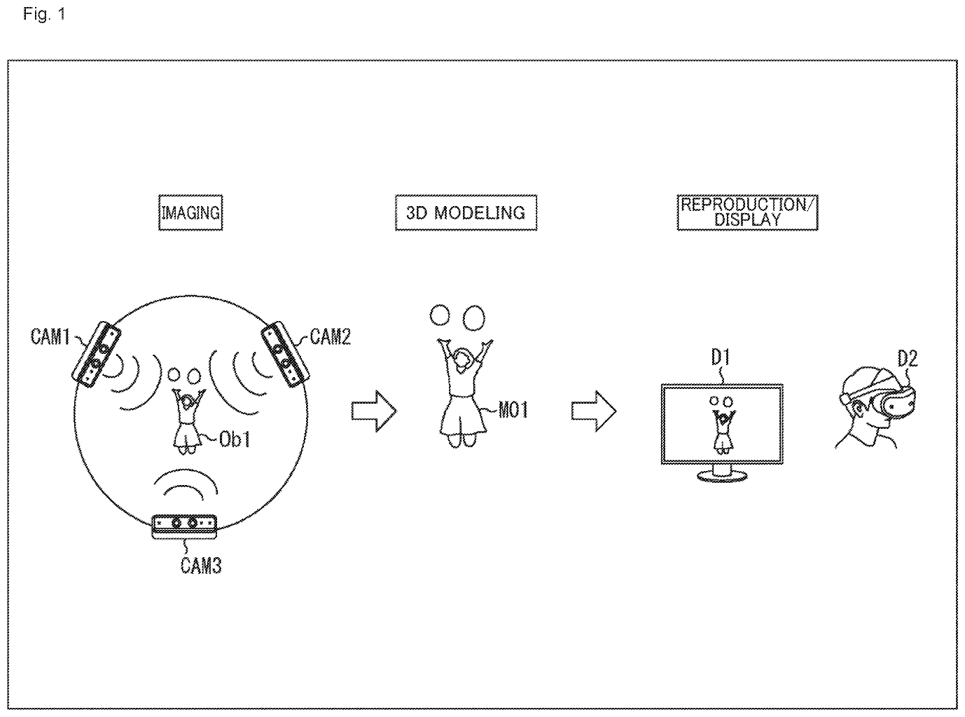

First, referring to FIG. 1, the generation of a 3D model of a subject and the display of a free viewpoint image using the 3D model will be briefly described below.

For example, a plurality of captured images can be obtained by imaging a predetermined imaging space, in which subjects such as a person are disposed, from the outside by using a plurality of imaging devices. The captured image includes, for example, a moving image. In the example of FIG. 1, three imaging devices CAM1 to CAM3 are disposed around a subject Ob1. The number of imaging devices CAM is not limited to three, and any number of imaging devices CAM may be provided. The number of imaging devices CAM during imaging is equivalent to the known number of viewpoints when a free viewpoint image is generated, and thus the larger the number of imaging devices CAM, the higher the accuracy of presentation of the free viewpoint image. The subject Ob1 in FIG. 1 is assumed to be a person making a predetermined motion.

A 3D object MO1, which is a 3D model of the subject Ob1 to be displayed in the imaging space, is generated by using the captured images obtained from the plurality of imaging devices CAM in different directions (3D modeling). The 3D object MO1 is generated by using, for example, a scheme such as Visual Hull in which a three-dimensional shape of a subject is cut out using images captured in different directions.

From one or more 3D objects in the imaging space, data on the one or more 3D objects (hereinafter also referred to as 3D model data) is transmitted to a device on the reproduction side and is reproduced therein. In other words, by rendering the acquired 3D object based on the data on the 3D object in the device on the reproduction side, a two-dimensional image of the 3D object is displayed on the viewing device of a viewer. FIG. 1 illustrates an example in which the viewing device is a display D1 or a head-mounted display (HMD) D2.

On the reproduction side, only a 3D object to be viewed can be requested from one or more 3D objects in the imaging space and can be displayed on the viewing device. For example, on the reproduction side, a virtual camera is assumed to have an imaging range equivalent to the viewing range of a viewer, and only a 3D object to be captured by the virtual camera is requested from multiple 3D objects in the imaging space and is displayed on the viewing device. The viewpoint (virtual viewpoint) of the virtual camera may be set at any position such that a viewer can view a subject from any viewpoint in the real world. A background image representing a predetermined space can be optionally combined with the 3D object.

<2. Configuration Example of Image Processing System>

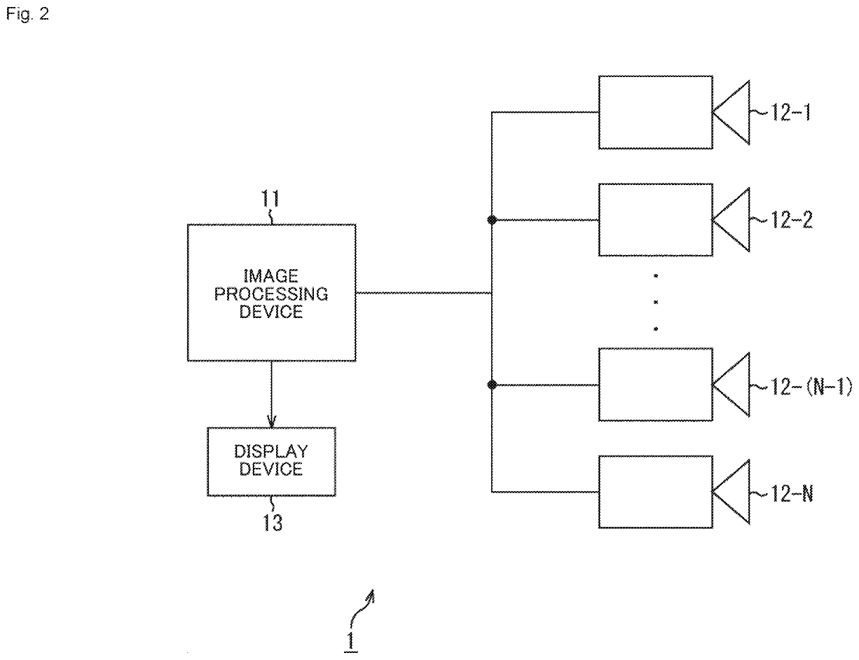

FIG. 2 illustrates a configuration example of the image processing system to which the present technique is applied, the image processing system being configured to capture moving images for generating a 3D model.

An image processing system 1 of FIG. 2 includes an image processing device 11, N (N>1) cameras 12-1 to 12-N, and a display device 13.

The N cameras 12-1 to 12-N are imaging devices that capture subject images. As described with reference to FIG. 1, the cameras 12-1 to 12-N are disposed at different locations around a subject. Hereinafter, the N cameras 12-1 to 12-N will be simply referred to as cameras 12 unless otherwise specified.

The image processing device 11 includes, for example, a personal computer and a server. The image processing device 11 controls the timing of imaging by the cameras 12-1 to 12-N, acquires moving images captured by the cameras 12, and performs predetermined image processing such as the generation of a 3D model based on the acquired moving images.

In order to allow the image processing device 11 to generate a 3D model of a subject by using moving images captured by the cameras 12, the positional relationship among the cameras 12 needs to be a known relationship. Moreover, in order to calculate the positional relationship among the cameras 12, the moving images of the cameras 12 need to be synchronized with one another. Thus, before imaging for generating a 3D model, the image processing device 11 performs calibration for calculating the positional relationship among the cameras 12, specifically, the positions and orientations of the cameras 12 on world coordinates by using the synchronized moving images of the cameras 12. The positions and orientations of the cameras 12 are the external parameters of the cameras 12. The internal parameters of the cameras 12 are assumed to be known parameters.

When the image processing device 11 causes the cameras 12 to capture images, the image processing device 11 generates a control signal for providing an instruction to start or terminate the capturing of images and a synchronizing signal, and supplies the signals to each of the cameras 12-1 to 12-N.

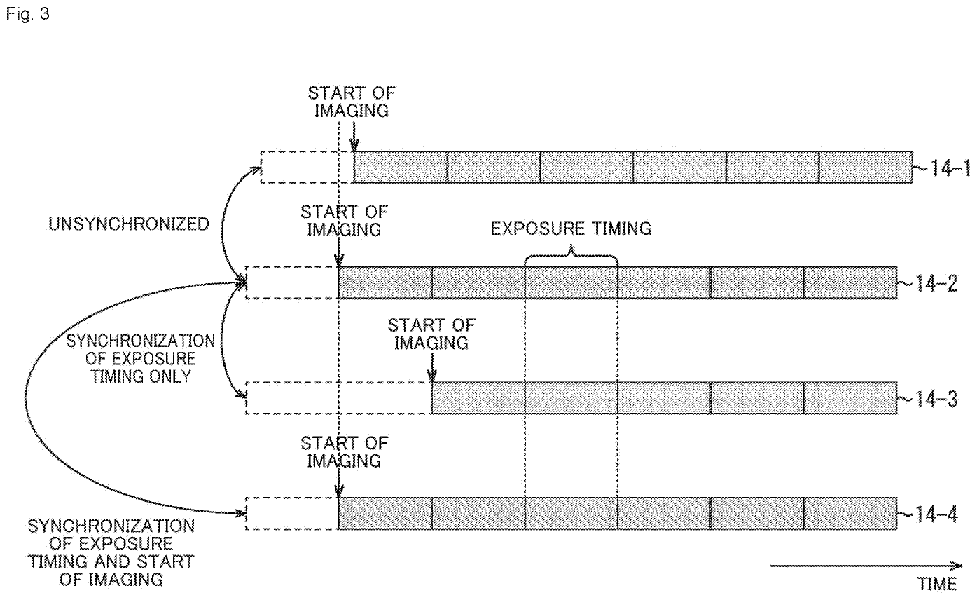

Referring to FIG. 3, the synchronization of moving images at the time of imaging by the plurality of cameras 12 will be described below.

FIG. 3 illustrates four moving images 14-1 to 14-4. The four moving images 14-1 to 14-4 are divided at regular intervals in the time direction. One section of the moving image 14 corresponds to a period from the start to the end of a single exposure and represents (a frame image of) one frame.

The timings to start capturing the moving image 14-1 and the moving image 14-2 are not synchronized with each other, and the phases of exposure timing (the timings to start and terminate exposure) are not synchronized with each other.

The timings to start capturing the moving image 14-2 and the moving image 14-3 are not synchronized with each other, but the phases of exposure timing are synchronized with each other.

The timings to start capturing the moving image 14-2 and the moving image 14-4 are synchronized with each other, and the phases of exposure timing are also synchronized with each other.

Moving images generated by the cameras 12-1 to 12-N on the basis of the control signal for starting and terminating the capturing of images and the synchronizing signal have the synchronization relationship like the moving image 14-2 and the moving image 14-3, the control signal and the synchronizing signal being supplied from the image processing device 11. In other words, the moving images are generated by the cameras 12-1 to 12-N such that the phases of exposure timing are synchronized with each other, but the timings to start capturing the moving images are not synchronized with each other.

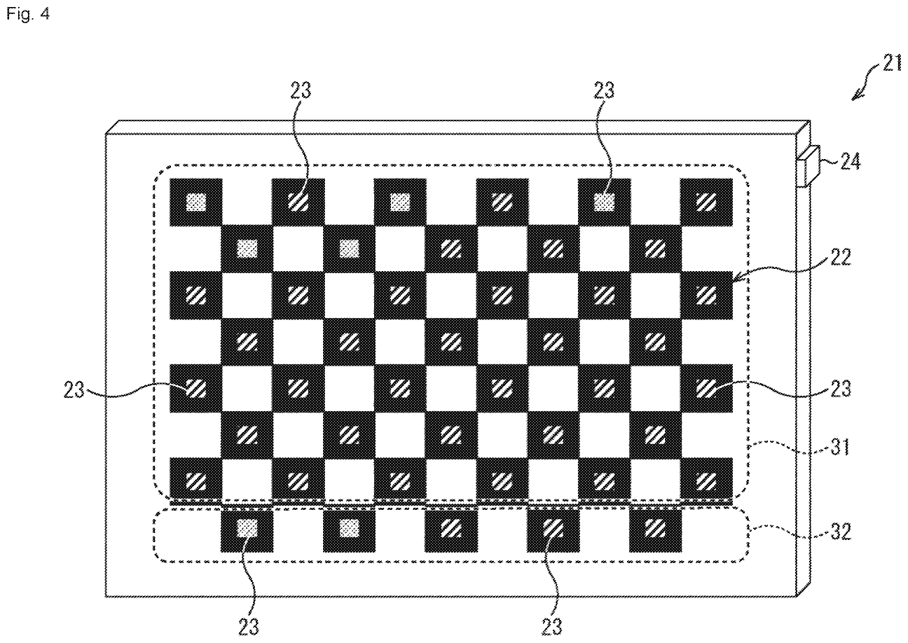

Returning to FIG. 2, the image processing device 11 causes the cameras 12 to capture images of a predetermined subject in order to calculate the positional relationship among the cameras 12. The subject is, for example, a calibration board (e.g., a calibration board 21 in FIG. 4) having a predetermined image pattern. The image processing device 11 acquires the moving images of the calibration board from the cameras 12, synchronizes the timings to start capturing the moving images, and performs calibration for calculating the external parameters of the cameras 12.

In a state where the positional relationship among the cameras 12 is known due to the calibration, the image processing device 11 causes the cameras 12 to capture images of a predetermined subject serving as a target of 3D model generation. For example, the cameras 12 capture images of a person making a predetermined motion, as a predetermined subject serving as a target of 3D model generation. The image processing device 11 generates a 3D model of an object, which is a person imaged as a subject, from multiple moving images supplied from the cameras 12-1 to 12-N.

Furthermore, the image processing device 11 can generate a virtual viewpoint image by viewing the generated 3D model of the object from any virtual viewpoint and display the image on the display device 13. The display device 13 includes, for example, the display D1 or the head-mounted display (HMD) D2 that are illustrated in FIG. 1.

Communications between the image processing device 11 and the cameras 12-1 to 12-N and communications between the image processing device 11 and the display device 13 may be direct communications via a cable or the like or communications via a predetermined network, e.g., a LAN (Local Area Network) or the Internet. The communications may be wire communications or radio communications. The image processing device 11 and the display device 13 may be integrated into a single unit.

In the image processing system 1 configured thus, calibration for calculating the positional relationship among the cameras 12, that is, the externa parameters of the cameras 12 is first performed by using moving images of a predetermined calibration board imaged by the cameras 12.

When the positional relationship among the cameras 12 is known, a predetermined subject as a target of 3D model generation is imaged by the cameras 12, and a 3D model of an object, which is the predetermined subject, is generated on the basis of multiple moving images captured by the cameras 12.

<3. Calibration Using Calibration Board>

First, calibration using the calibration board will be described in detail.

FIG. 4 illustrates an example of the calibration board used for calibration.

A calibration board 21 in FIG. 4 has an image pattern 22 in a so-called checkered pattern (chess pattern), in which square black patterns and white patterns are alternately disposed in the vertical direction and the horizontal direction, on a predetermined plane serving as the front side of a thin-plate shape. A light-emitting part 23 is disposed in each of the black patterns of the image pattern 22 in the checkered pattern. The image pattern 22 in the checkered pattern in FIG. 4 has 44 black patterns, so that the number of light-emitting parts 23 is 44.

Moreover, at least one operation button 24 is disposed at a predetermined point of the calibration board 21. The operation button 24 is operated by a user when an operation is performed to start or terminate a light-emitting operation in the 44 light-emitting parts 23.

The light-emitting part 23 disposed in each of the black patterns of the image pattern 22 is composed of an LED (Light Emitting Diode) or the like. The light-emitting part 23 can provide two lighting conditions, for example, an illuminated state and an unilluminated state of white light. Alternatively, the light-emitting parts 23 may illuminate in multiple colors, for example, red and green.

The 44 light-emitting parts 23 are grouped into a time display part 31 that illuminates according to a time, and a position display part 32 that illuminates according to a position. In the example of FIG. 4, from among the 44 light-emitting parts 23, the 39 light-emitting parts 23 in the upper part are allocated to the time display part 31, whereas the other five light-emitting parts 23 are allocated to the position display part 32.

The time display part 31 illuminates to perform time synchronization on moving images captured by the plurality of cameras 12. The time display part 31 associates “illuminated” or “unilluminated” of the light-emitting part 23 with a bit of “0” or “1.” The 39 light-emitting parts 23 display 39-bit time information.

The position display part 32 associates “illuminated” or “unilluminated” of the light-emitting part 23 with a bit of “0” or “1.” The five light-emitting parts 23 display 5-bit position information.

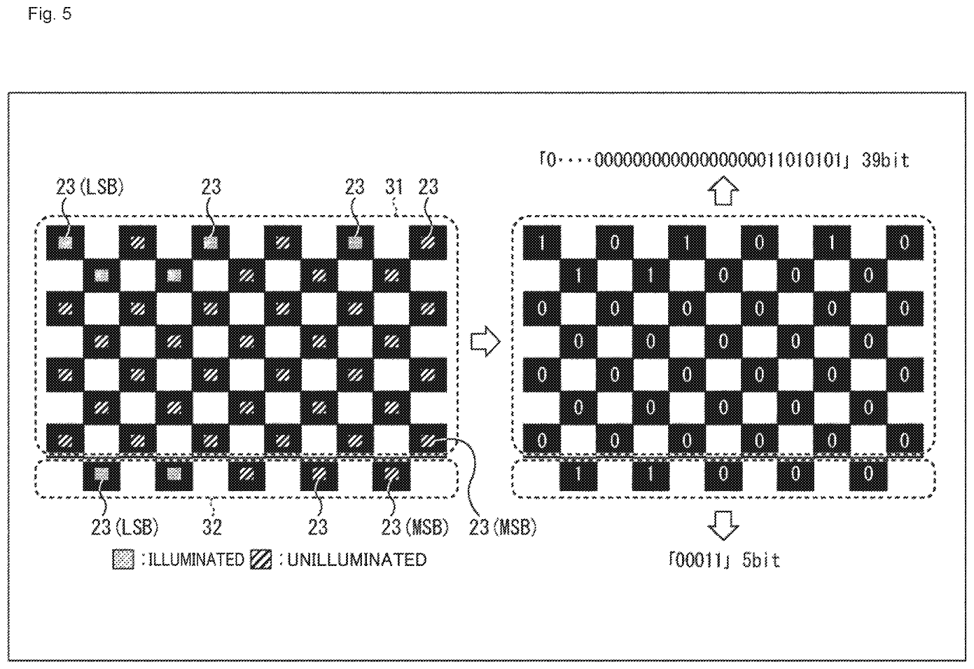

For example, as illustrated in FIG. 5, the time display part 31 constitutes 39-bit bit strings in which the light-emitting part 23 on the upper left end serves as a least significant bit (LSB) and the light-emitting part 23 on the lower right end serves as a most significant bit (MSB) in a raster scan sequence. When the light-emitting parts 23 of the time display part 31 are illuminated or unilluminated as illustrated in the example of FIG. 5, the time display part 31 displays “000000000000000000000000000000011010101.”

The position display part 32 constitutes 5-bit bit strings in which the light-emitting part 23 on the left end serves as a least significant bit (LSB) and the light-emitting part 23 on the right end serves as a most significant bit (MSB). When the light-emitting parts 23 of the position display part 32 are illuminated or unilluminated as illustrated in the example of FIG. 5, the position display part 32 displays “00011.”

If the light-emitting parts 23 can provide illumination in multiple colors, “0” or “1” may be represented by a color difference instead of illuminated/unilluminated. For example, “red illumination” may be represented as “1” and “green illumination” may be represented as “0.”

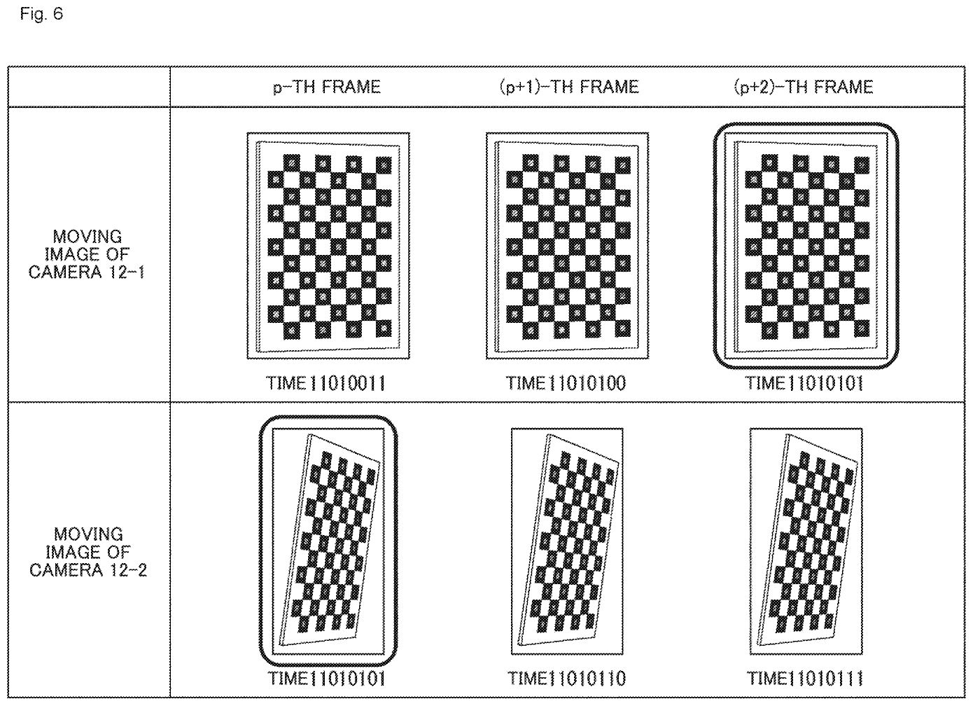

Referring to FIG. 6, a method of using the time display part 31 of the calibration board 21 in the calibration will be described below.

The time display part 31 increments (updates) a 39-bit bit value on the basis of the internal timer of the calibration board 21 at each lapse of a predetermined unit time. In the calibration, the cameras 12 capture the moving images of the calibration board 21, and the lighting pattern of the time display part 31 of the calibration board 21 is identified in the moving images, thereby determining an imaging time.

FIG. 6 illustrates an example of the moving images of the calibration board 21 when the moving images are captured by the cameras 12-1 and 12-2.

The lighting pattern of the time display part 31 of the calibration board 21 in the moving images of FIG. 6 is originally represented by 39-bit bit values. However, the higher-order 31 bits of the lighting pattern of the time display part 31 in the moving images of FIG. 6 are all “0” and thus only the lower-order 8 bits are described.

The p-th frame (p is a natural number) of the moving image captured by the camera 12-1 in the calibration includes the calibration board 21 in which the time display part 31 has a lighting pattern “11010011.” The (p+1)-th frame includes the calibration board 21 in which the time display part 31 has a lighting pattern “11010100.” The (p+2)-th frame includes the calibration board 21 in which the time display part 31 has a lighting pattern “11010101.”

The p-th frame of the moving image captured by the camera 12-2 in the calibration includes the calibration board 21 in which the time display part 31 has a lighting pattern “11010101.” The (p+1)-th frame includes the calibration board 21 in which the time display part 31 has a lighting pattern “11010110.” The (p+2)-th frame includes the calibration board 21 in which the time display part 31 has a lighting pattern “11010111.”

Thus, in the (p+2)-th frame of the camera 12-1 and the p-th frame of the camera 12-2, the frames being surrounded by frames in FIG. 6, the time display part 31 has the common lighting pattern “11010111,” proving that the frames have been captured at the same time.

As described with reference to FIG. 3, the phases of the exposure timing of the moving images captured by the plurality of cameras 12 are synchronized with each other, but the timings to start capturing the moving images are not synchronized with each other. Thus, synchronization is necessary between the timings to start capturing the moving images.

As illustrated in FIG. 6, the times when the moving images are captured are detected on the basis of the lighting patterns of the time display part 31 in the frame images of the captured moving images, thereby detecting the frame images captured at the same time. In other words, synchronization can be achieved between the timings to start capturing the moving images.

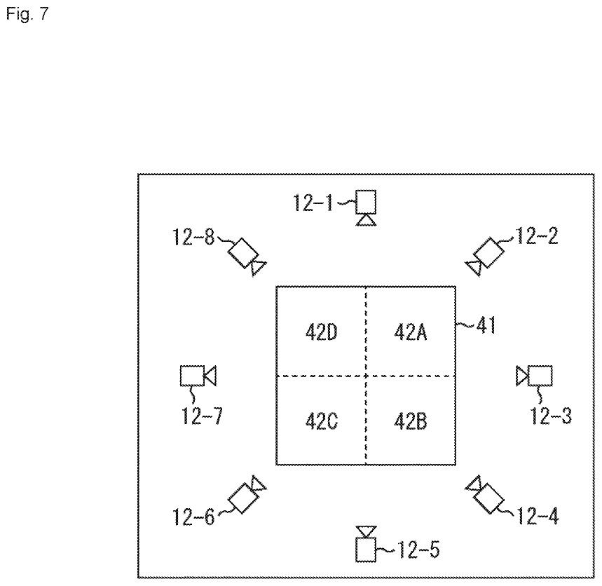

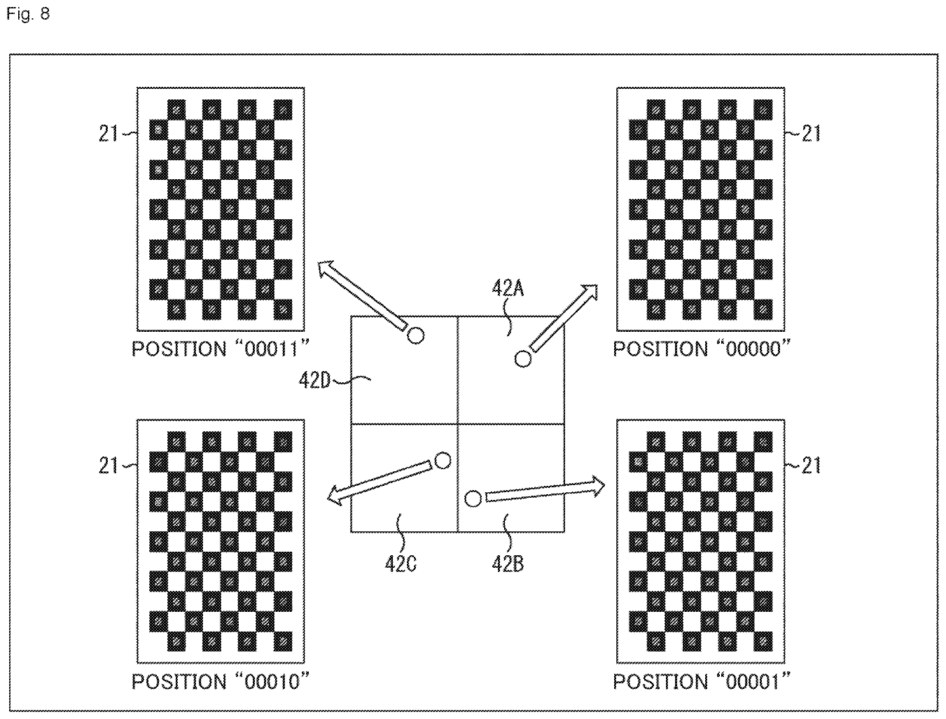

Referring to FIGS. 7 and 8, a method of using the position display part 32 of the calibration board 21 in the calibration will be described below.

FIG. 7 is a plan view (top view) illustrating, when N cameras in the image processing system 1 are eight cameras (N=8), the layout of eight cameras 12-1 to 12-8 and an example of an imaging space.

An imaging space 41 is determined on the basis of the imaging range of the eight cameras 12-1 to 12-8. In the example of FIG. 7, the imaging space 41 is set as a cubic (square) region in a region inside the eight cameras 12-1 to 12-8.

In the present embodiment, on the assumption that a user or a self-propelled robot moves with the calibration board 21 on the floor of the imaging space 41 when an image is captured, only a two-dimensional region corresponding to the floor of the imaging space 41 is examined. The imaging space 41 is also referred to as an imaging region 41.

The N cameras 12-1 to 12-N are annularly disposed at predetermined intervals (for example, regular intervals) outside the imaging region 41 so as to face the center of the imaging region 41.

The square imaging region 41 is divided into a plurality of sections 42. A predetermined bit value that can be represented by the position display part 32 is allocated to each of the sections 42.

For example, as illustrated in FIG. 7, the square imaging region 41 is equally divided into four sections 42A to 42D. As illustrated in FIG. 8, a bit value of “00000” is allocated to the section 42A, a bit value of “00001” is allocated to the section 42B, a bit value of “00010” is allocated to the section 42C, and a bit value of “00011” is allocated to the section 42D.

The calibration board 21 includes a position information detection unit, for example, a GPS module capable of acquiring position information. The 5-bit position information of the position display part 32 is controlled according to the position of the calibration board 21 in one of the four sections 42A to 42D of the imaging region 41. In the calibration, the cameras 12 capture the moving images of the calibration board 21, and the lighting pattern of the position display part 32 of the calibration board 21 is identified in the moving images, thereby determining the position of the calibration board 21, specifically, which one of the sections 42A to 42D has the calibration board 21 when an image is captured.

It is known that the accuracy of calibration for calculating the positional relationship among the cameras 12 is increased by detecting the feature points of the image pattern 22 of the calibration board 21 at various positions evenly in the imaging region (imaging space) 41.

The section of the frame image captured as the calibration board 21 can be determined by identifying the lighting pattern of the position display part 32 of the calibration board 21 included in the frame images of in the moving images captured by the cameras 12, so that the frame image used for calibration can be evenly selected from the four sections 42A to 42D in the imaging region 41.

In the example of FIGS. 7 and 8, the imaging region 41 is divided into four sections 42. The number of divisions in the imaging region 41 is not limited to four and thus may be two, three, or five or more. In the foregoing example, only a two-dimensional region corresponding to the floor of the imaging space 41 is examined. The cubic imaging space 41 may be divided into a plurality of sections in a three-dimensional space. For example, even at the same plane position in the imaging space 41, different bit values may be allocated to a height H1 close to the floor and a height H2 remote from the floor.

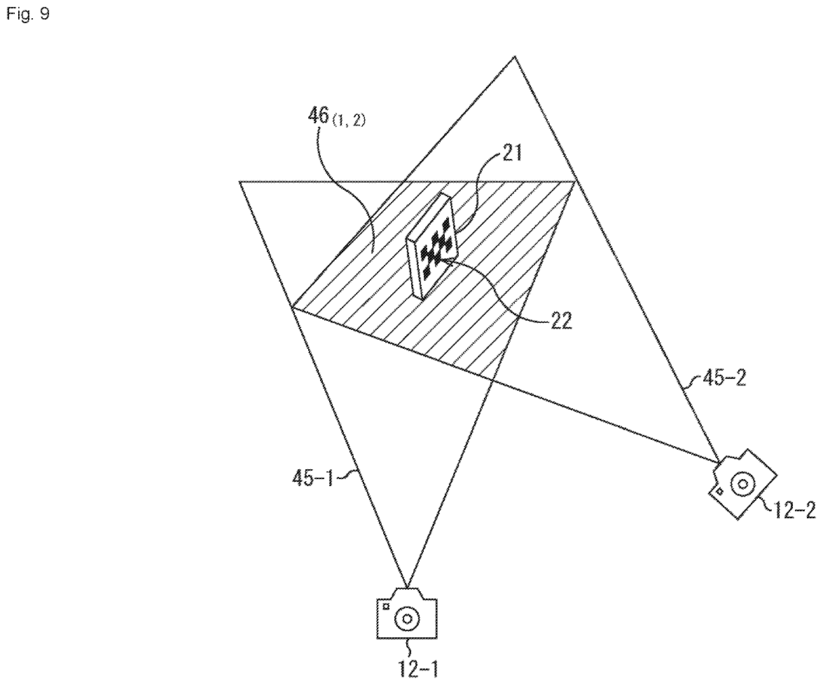

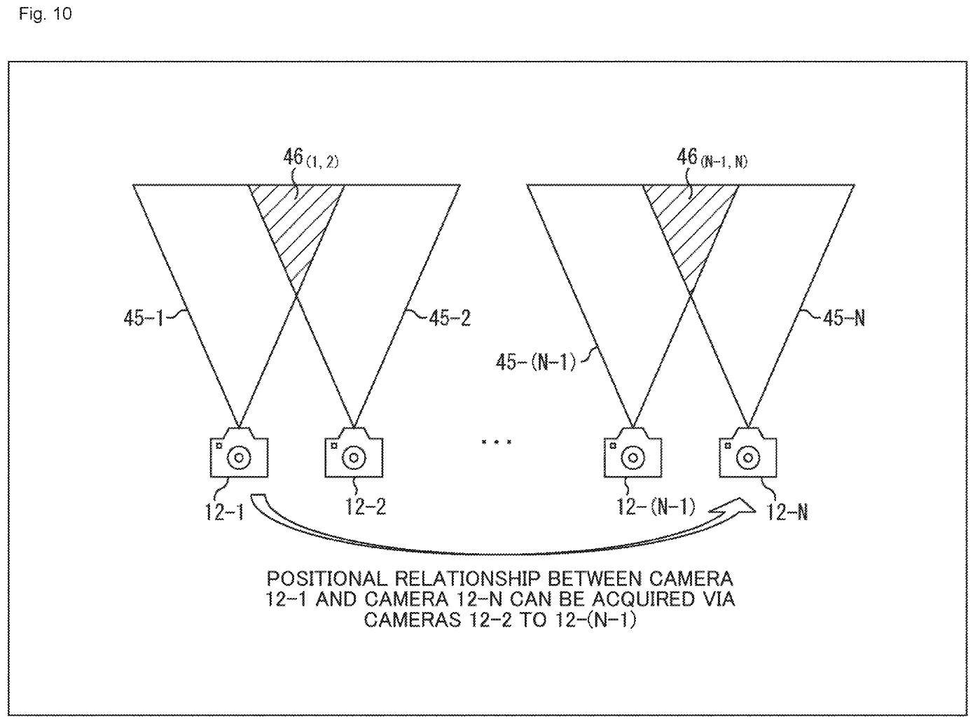

Referring to FIGS. 9 and 10, the calibration of the cameras 12 with the calibration board 21 will be described below.

As illustrated in FIG. 9, if the calibration board 21 is disposed in an imaging range 46_{(1,2)} shared by an imaging range 45-1 of the camera 12-1 and an imaging range 45-2 of the camera 12-2, the image processing device 11 detects the feature points of the image pattern 22 of the calibration board 21 in frame images captured by the cameras 12-1 and 12-2 and performs matching, thereby calculating the positional relationship between the cameras 12-1 and 12-2.

In this way, if the two cameras 12 have the common imaging range 46, the positional relationship between the two cameras 12 can be directly calculated on the basis of the feature points of the image pattern 22 of the calibration board 21 in frame images captured in synchronization with each other by the two cameras 12.

For example, even if the two cameras 12-1 and 12-N do not have the common imaging range 46 as illustrated in FIG. 10, imaging ranges 45 are indirectly coupled between the camera 12-1 and the camera 12-N via the imaging ranges 45 of one or more other cameras 12 (cameras 12-2 to 12-(N−1)), for example, the cameras 12-1 and 12-2 have a common imaging range 46_{(1,2)}, the cameras 12-2 and 12-3 have a common imaging range 46_{(2,3)}, and the cameras 12-(N−1) and 12-N have a common imaging range 46_{(N-1,N)}, so that the positional relationship between the cameras 12-1 and 12-N can be indirectly calculated by sequentially calculating the positional relationships among the cameras 12-1 to 12-N having the common imaging ranges 46.

<4. Block Diagram>

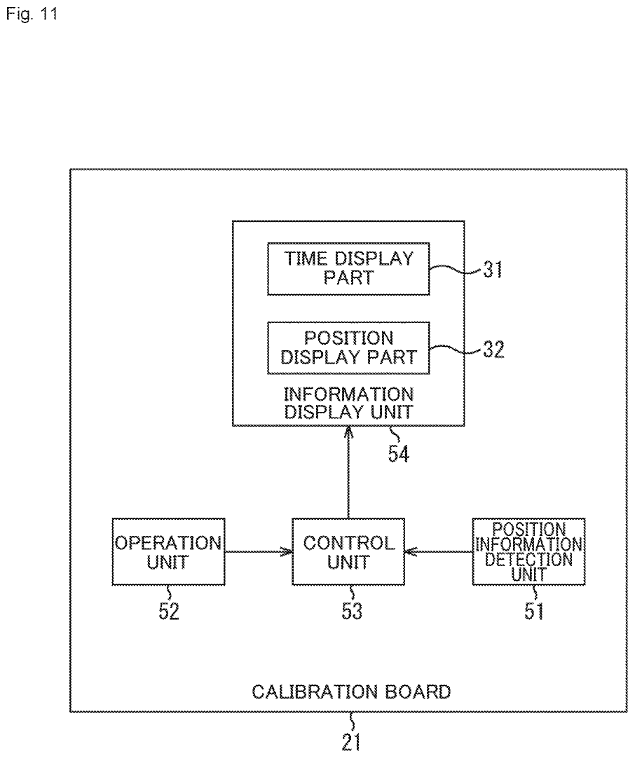

FIG. 11 is a block diagram illustrating a configuration example of the calibration board 21.

The calibration board 21 includes a position information detection unit 51, an operation unit 52, a control unit 53, and an information display unit 54.

The position information detection unit 51 includes, for example, a GPS (Global Positioning System) module. The position information detection unit 51 detects current position information on the calibration board 21 and supplies the information to the control unit 53.

The operation unit 52 corresponds to the operation button 24 of FIG. 4. The operation unit 52 receives a user operation and supplies, to the control unit 53, an operation signal corresponding to the received user operation.

The control unit 53 controls the display of the information display unit 54, specifically, the lighting of the 44 light-emitting parts 23 on the basis of the position information supplied from the position information detection unit 51 and the operation signal supplied from the operation unit 52.

The information display unit 54 corresponds to the 44 light-emitting parts 23 of FIG. 4 and includes the time display part 31 and the position display part 32. The information display unit 54 illuminates or does not illuminate each of the 44 light-emitting parts 23 under the control of the control unit 53. The time display part 31 illuminates according to a time. The position display part 32 illuminates according to the position of the calibration board 21, specifically, the four sections 42A to 42D of the imaging region 41. If the light-emitting parts 23 can illuminate in multiple colors, the light-emitting parts 23 illuminates in a predetermined color under the control of the control unit 53.

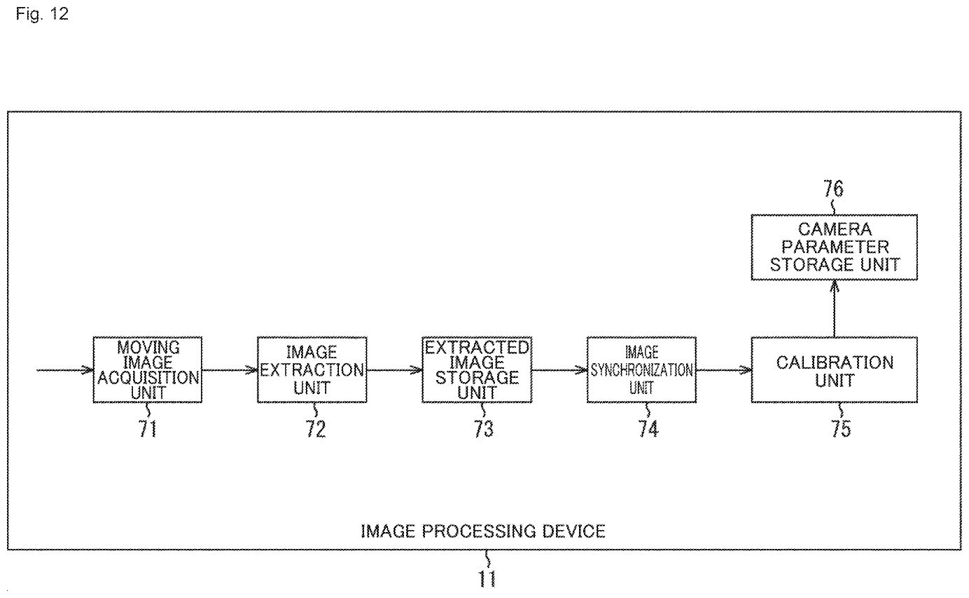

FIG. 12 is a block diagram illustrating a configuration example of the image processing device 11.

The image processing device 11 includes a moving image acquisition unit 71, an image extraction unit 72, an extracted image storage unit 73, an image synchronization unit 74, a calibration unit 75, and a camera parameter storage unit 76.

The moving image acquisition unit 71 acquires the moving images of the calibration board 21 from the plurality of cameras 12 and supplies the moving images to the image extraction unit 72.

The image extraction unit 72 performs image extraction for extracting a time lighting-pattern changed frame image from the moving image supplied from the plurality of cameras 12. More specifically, the image extraction unit 72 extracts, as a time lighting-pattern changed frame image, a frame image after the lighting pattern of the time display part 31 of the calibration board 21 in the moving image changes from that of the preceding frame image, and the image extraction unit 72 supplies the extracted time lighting-pattern changed frame image to the extracted image storage unit 73.

The extracted image storage unit 73 stores a plurality of time lighting-pattern changed frame images that are extracted from the moving images of the cameras 12 in the image extraction unit 72.

The image synchronization unit 74 selects the time lighting-pattern changed frame images such that the four sections 42A to 42D of the imaging region 41 are allocated in a predetermined ratio on the basis of the lighting conditions of the position display part 32 of the calibration board 21 in the time lighting-pattern changed frame images stored in the extracted image storage unit 73. For example, the image synchronization unit 74 selects the time lighting-pattern changed frame image such that the four sections 42A to 42D are equally allocated.

Furthermore, the image synchronization unit 74 performs time synchronization on the plurality of time lighting-pattern changed frame images, which are selected such that the sections 42 are allocated in a predetermined ratio, on the basis of the lighting conditions of the time display part 31 in the frame images. In other words, the image synchronization unit 74 collects frame images in which the lighting conditions of the time display part 31 indicate the same time. The plurality of time lighting-pattern changed frame images captured at the same time are supplied to the calibration unit 75.

The calibration unit 75 performs calibration for calculating the external parameters of the N cameras 12 by using the plurality of lighting-pattern changed frame images that are time-synchronized images. More specifically, by using a plurality of time lighting-pattern changed frame images captured by two cameras 12-A and 12-B (A and B are natural numbers of 1 to N and are different from each other) at the same time, the calibration unit 75 sequentially performs, on the N cameras 12-1 to 12-N, processing for calculating the positional relationship between the cameras 12-A and the camera 12-B. The external parameters of the N cameras 12 are stored in the camera parameter storage unit 76, the external parameters being obtained by the calibration.

The camera parameter storage unit 76 accommodates the external parameters of the N cameras 12, the external parameters being supplied from the calibration unit 75.

The image processing device 11 is configured as above:

<5. Position Pattern Assignment>

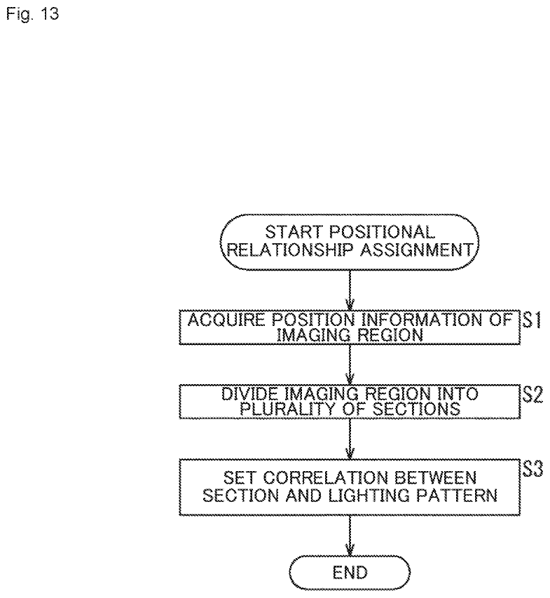

Referring to the flowchart of FIG. 13, the position pattern assignment of the calibration board 21 will be described below. The position pattern assignment is performed as preparation for capturing images of the calibration board 21 by the cameras 12. This processing is performed by the calibration board 21 when an operation to start the position pattern assignment is performed in, for example, the operation unit 52.

First, in step S1, the control unit 53 of the calibration board 21 acquires the position information of the imaging region 41. For example, when a user carrying the calibration board 21 moves in the outer edge of the imaging region 41, position information corresponding to the outer edge of the imaging region 41 is supplied from the position information detection unit 51 to the control unit 53 and is stored in internal memory, so that the position information of the imaging region 41 is acquired. The method of acquiring the position information of the imaging region 41 is not particularly limited. For example, position information on the four corners of a rectangle corresponding to the imaging region 41 may be inputted.

In step S2, the control unit 53 divides the imaging region 41 into the plurality of sections 42 after the position information is acquired. For example, as illustrated in FIG. 7, it is determined in advance that the rectangular imaging region 41 is to be equally divided into the four sections 42A to 42D. The control unit 53 divides the imaging region 41 into the four sections 42 after the position information is acquired. The method of dividing the imaging region 41 and the number of divisions are optionally determined and are not particularly limited. For example, a user carrying the calibration board 21 may enter the number of divisions of the sections 42 via the operation unit 52, and then the imaging region 41 may be divided according to the inputted number of divisions.

In step S3, the control unit 53 sets a correlation between the plurality of sections 42 split in the imaging region 41 and the lighting pattern of the position display part 32 and stores the correlation. Specifically, as illustrated in FIG. 8, the control unit 53 correlates a predetermined 5-bit bit value with each other the sections 42A to 42D split in the imaging region 41, and stores the correlation result in the internal memory. Any method may be used for correlating the sections 42 with 5-bit bit values. For example, a user may sequentially specify the four sections 42A to 42D split in step S2, and the control unit 53 may assign “00000,” “00001,” “00010,” and “00011” to the sections in the order in which the sections are specified.

In step S3, when the correlation between the plurality of sections 42 split in the imaging region 41 and the lighting pattern of the position display part 32 is stored in the control unit 53, the position pattern assignment is completed.

At the completion of the position pattern assignment of FIG. 13, the preparation for capturing the images of the calibration board 21 with the plurality of cameras 12 is completed. Thus, processing is performed to capture the images of the calibration board 21 in the imaging region 41 with the cameras 12.

In the processing for capturing the images of the calibration board 21, the control signal for providing an instruction to start capturing images and the synchronizing signal are supplied from the image processing device 11 to the cameras 12. The cameras 12 start capturing images in response to the control signal for providing an instruction to start capturing images, and capture moving images (capture a moving image for each frame) in response to the synchronizing signal.

While the cameras 12 capture moving images, for example, the user carrying the calibration board 21 moves in the imaging region 41. The cameras 12 capture at least the moving images of the calibration board 21 in the imaging region 41.

<6. Time Information Lighting>

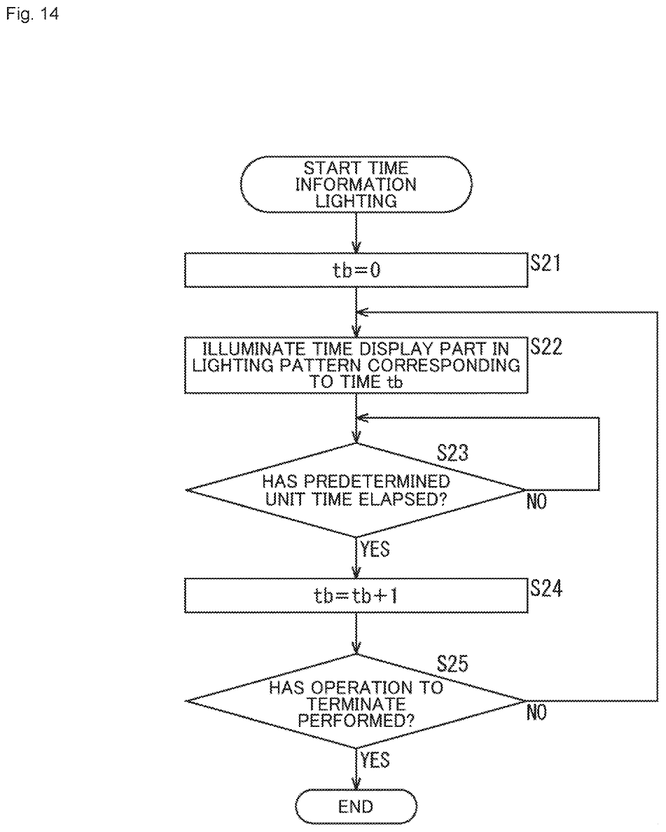

FIG. 14 is a flowchart of time information lighting performed on the calibration board 21 while the cameras 12 capture images. This processing is started, for example, when the user carrying the calibration board 21 operates the operation unit 52 to start illuminating the information display unit 54.

First, in step S21, the control unit 53 sets “0” for a variable tb corresponding to the time information of the time display part 31. The variable tb corresponds to a value obtained by expressing, as a decimal number, a 39-bit bit value in binary form.

In step S22, the control unit 53 illuminates the time display part 31 (39 light-emitting parts 23) in a lighting pattern corresponding to a time tb. The lighting pattern corresponding to the time tb is a pattern in which the variable tb in decimal form is represented as a 39-bit bit string (binary), “0” represents an unilluminated state, and “1” represents an illuminated state.

In step S23, the control unit 53 determines whether a predetermined unit time has elapsed. The processing of step S23 is repeated until it is determined that the predetermined unit time has elapses. The predetermined unit time corresponds to the time of one bit of the time display part 31.

If it is determined that the predetermined unit time has elapsed in step S23, the processing advances to step S24, and the control unit 53 increments the variable tb, which corresponds to time information, by “1.”

In step S25, it is determined whether an operation to terminate the lighting of the information display unit 54 has been performed.

If it is determined in step S25 that the operation to terminate the lighting of the information display unit 54 has not been performed, the processing returns to step S22, and the processing of steps S22 to S25 is performed again. In other words, the time display part 31 (39 light-emitting parts 23) is illuminated for the predetermined unit time in the lighting pattern corresponding to the variable tb incremented by “1.”

In step S25, if it is determined that the operation to terminate the lighting of the information display unit 54 has been performed, the time information lighting is terminated.

As described above, the information display unit 54 of the calibration board 21 changes the lighting condition at each lapse of the unit time.

<7. Position Information Lighting>

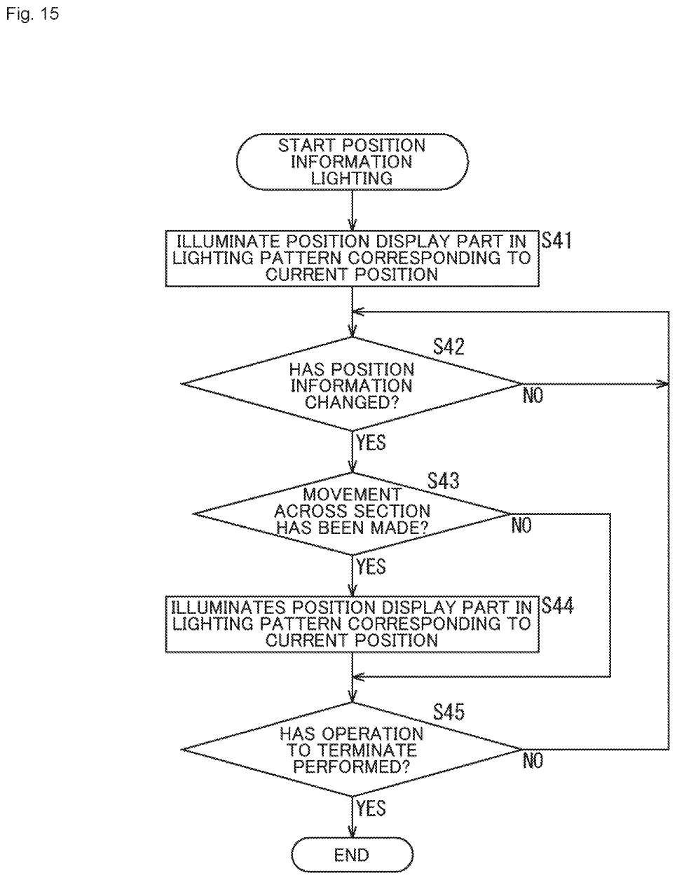

FIG. 15 is a flowchart of position information lighting performed on the calibration board 21 concurrently with the time information lighting in FIG. 14 while the cameras 12 capture images. This processing is started, for example, when the user carrying the calibration board 21 operates the operation unit 52 to start illuminating the information display unit 54.

First, in step S41, the control unit 53 acquires current position information from the position information detection unit 51 and illuminates the position display part 32 (5 light-emitting parts 23) in a lighting pattern corresponding to the current position. The lighting pattern corresponding to the current position is a pattern in which “0” represents an unilluminated state, and “1” represents an illuminated state in a 5-bit bit string (binary) assigned to the section 42 including the current position.

In step S42, the control unit 53 determines whether position information supplied from the position information detection unit 51 has changed. The processing of step S42 is repeated until it is determined that the position information has changed.

In step S42, if it is determined that the position information has changed, the processing advances to step S43. The control unit 53 determines whether a movement across the section 42 of the imaging region 41 has been made before and after a change of the position information.

In step S43, if it is determined that a movement across the section 42 has been made before and after a change of the position information, the processing advances to step S44, and the control unit 53 illuminates the position display part 32 (five light-emitting parts 23) in the lighting pattern corresponding to the current position.

If it is determined in step S43 that a movement across the section 42 has not been made, step S44 is skipped.

In step S45, the control unit 53 determines whether an operation to terminate the lighting of the information display unit 54 has been performed.

If it is determined in step S45 that the operation to terminate the lighting of the information display unit 54 has not been performed, the processing returns to step S42, and the processing of steps S42 to S45 is performed again. In other words, the processing for illuminating the position display part 32 (five light-emitting parts 23) is continued in the lighting pattern corresponding to the current position.

In step S45, if it is determined that the operation to terminate the lighting of the information display unit 54 has been performed, the position information lighting is terminated.

As described above, the position display part 32 of the calibration board 21 changes the lighting condition according to the sections 42.

The time information lighting in FIG. 14 and the position information lighting in FIG. 15 are simultaneously started in response to an operation to start the lighting of the information display unit 54 and are simultaneously terminated in response to an operation to terminate the lighting of the information display unit 54.

<8. Image Extraction>

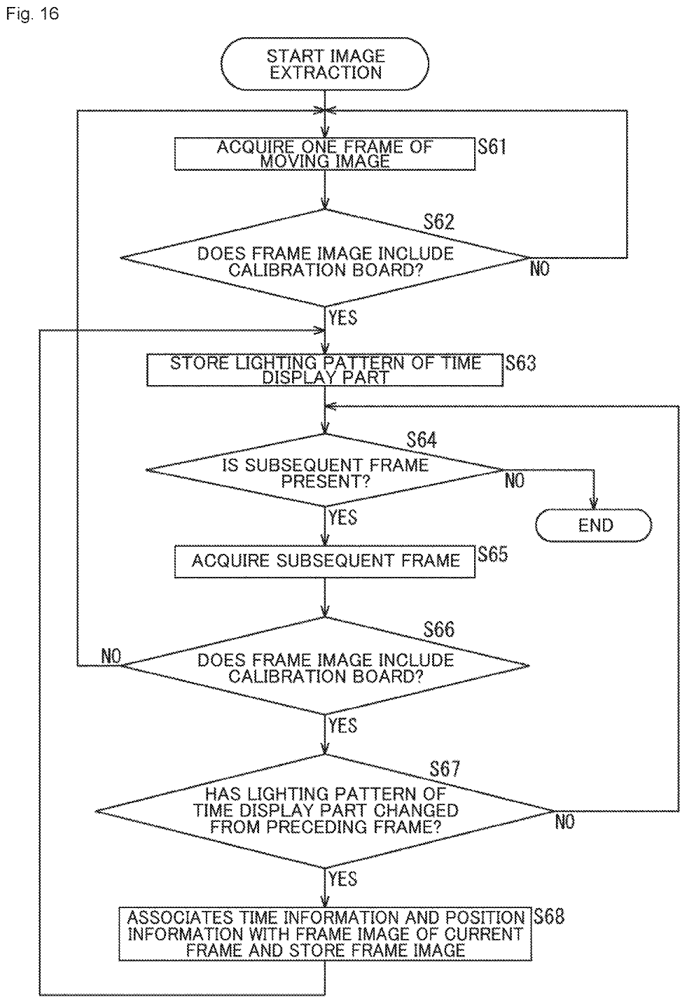

Referring to the flowchart of FIG. 16, image extraction performed by the moving image acquisition unit 71, the image extraction unit 72, and the extracted image storage unit 73 of the image processing device 11 will be described below.

The moving images of the calibration board 21 are inputted from the plurality of cameras 12 to the image processing device 11. The image extraction of FIG. 16 is performed on the inputted moving images of the cameras 12. Specifically, for example, if the moving images of the calibration board 21 are captured by the eight cameras 12-1 to 12-8, the image extraction of FIG. 16 is performed on each of the eight moving images.

In the present embodiment, it is assumed that the unit time of one frame based on the frame rate of a moving image is shorter than a unit time during which the lighting pattern of the time display part 31 of the calibration board 21 changes and timings to start capturing images are synchronized with each other in a frame immediately after the lighting pattern of the time display part 31 changes.

First, in step S61, the moving image acquisition unit 71 acquires (a frame image of) one frame of a moving image inputted from the camera 12 and supplies the frame to the image extraction unit 72.

In step S62, the image extraction unit 72 determines whether the frame image supplied from the moving image acquisition unit 71 includes the calibration board

If it is determined in step S62 that the frame image supplied from the moving image acquisition unit 71 does not include the calibration board 21, the processing returns to step S61 and the processing of steps S61 and S62 is performed again. Thus, the frame images of moving images are searched until it is determined that the frame image includes the calibration board 21.

In step S62, if it is determined that the frame image includes the calibration board 21, the processing advances to step S63. The image extraction unit 72 identifies the lighting pattern of the time display part 31 of the calibration board 21 in the frame image and stores the lighting pattern therein.

Subsequently, in step S64, the moving image acquisition unit 71 determines whether (a frame image of) the subsequent frame of a moving image is present, in other words, whether a subsequent frame has been inputted from the camera 12.

In step S64, if it is determined that the subsequent frame of a moving image is absent, the image extraction is terminated.

If it is determined in step S64 that the subsequent frame of a moving image is present, the processing advances to step S65. The moving image acquisition unit 71 acquires (a frame image of) the subsequent frame inputted from the camera 12 and supplies the frame to the image extraction unit 72. The frame acquired in step S61 will be referred to as the preceding frame, and the frame acquired in step S65 will be referred to as the current frame.

In step S66, the image extraction unit 72 determines whether the frame image of the current frame supplied from the moving image acquisition unit 71 includes the calibration board 21.

If it is determined in step S66 that the frame image of the current frame does not include the calibration board 21, the processing returns to step S61 and the processing of step S61 and later is performed again. Specifically, if the calibration board 21 is not included in any one of the frame images of the preceding frame and the current frame, the image processing device 11 acquires a preceding frame again.

If it is determined in step S66 that the frame image of the current frame includes the calibration board 21, the processing advances to step S67. The image extraction unit 72 determines whether the lighting pattern of the time display part 31 in the frame image of the current frame has changed from the frame image of the preceding frame.

If it is determined in step S67 that the lighting pattern of the time display part 31 of the current frame has not changed from the frame image of the preceding frame, the processing returns to step S64 and the foregoing steps S64 to S67 are repeated. In steps S64 to S67, the subsequent frame of the moving image is acquired as the current frame, and it is determined whether the lighting pattern of the time display part 31 has changed.

If it is determined in step S67 that the lighting pattern of the time display part 31 of the current frame has changed from the frame image of the preceding frame, the processing advances to step S68. The image extraction unit 72 associates time information identified from the lighting pattern of the time display part 31 and position information (section 42) identified from the lighting pattern of the position display part 32 with the frame image of the current frame, and stores the frame image in the extracted image storage unit 73. The stored frame image of the current frame in the extracted image storage unit 73 is the time lighting-pattern changed frame image.

After step S68, the processing returns to step S63, and the foregoing processing is repeated. Specifically, the lighting pattern of the time display part 31 of the calibration board 21 in the frame image of the current frame is internally stored as the information of the preceding frame, the subsequent frame is acquired as the current frame, it is determined whether the lighting pattern of the time display part 31 has changed in the current frame from the preceding frame, and if the lighting pattern has been changed, time information and position information are stored while being associated with the frame image of the current frame. If it is determined that the subsequent frame of the moving image is absent, the image extraction is terminated.

Through the image extraction, at least one time lighting-pattern changed frame image is extracted from a moving image and is stored in the extracted image storage unit 73 along with the time information and position information of the calibration board 21 in the frame image.

The image extraction of FIG. 16 is performed on a moving image inputted from each of the cameras 12. Thus, a time lighting-pattern changed frame image is collected for a moving image captured by each of the cameras 12 and is stored in the extracted image storage unit 73.

The image processing device 11 may temporarily store moving images, which are outputted from the cameras 12, in the device and then perform the image extraction of FIG. 16 for each of the cameras 12. Alternatively, the image processing device 11 may simultaneously perform the image extraction of FIG. 16 on two or more moving images.

In the image extraction, as described above, a frame image is extracted when the lighting pattern of the time display part 31 changes. Thus, the unit time of one frame of a moving image is preferably shorter than the unit time during which the lighting pattern of the time display part 31 of the calibration board 21 changes. The unit time of one frame of a moving image may be set longer than or as long as the unit time during which the lighting pattern of the time display part 31 changes.

<9. Calibration>

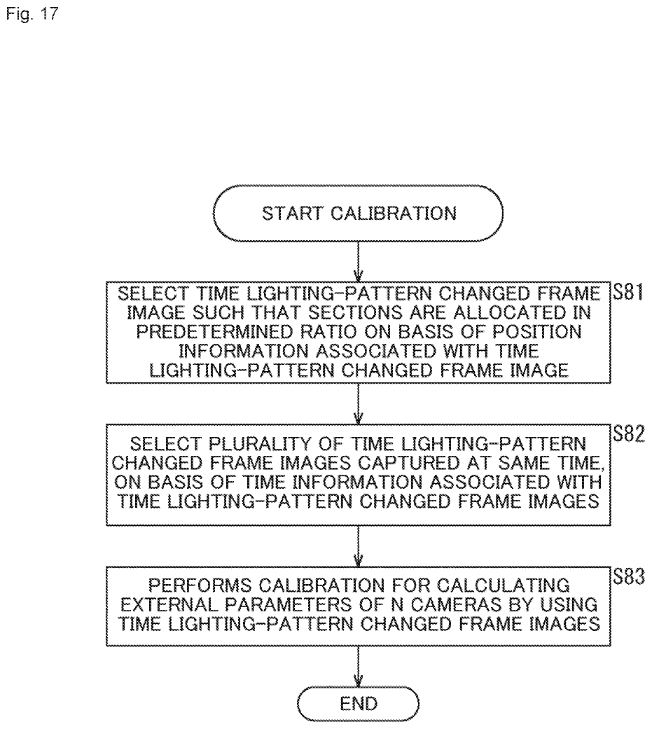

Referring to the flowchart of FIG. 17, calibration using the time lighting-pattern changed frame image, which is time-synchronized, will be described below. The calibration is performed by the image synchronization unit 74, the calibration unit 75, and the camera parameter storage unit 76 of the image processing device 11. The processing is performed after the completion of the image extraction of FIG. 16.

First, in step S81, the image synchronization unit 74 selects the time lighting-pattern changed frame images such that the four sections 42A to 42D of the imaging region 41 are allocated in a predetermined ratio on the basis of position information associated with the time lighting-pattern changed frame images of the extracted image storage unit 73. For example, the image synchronization unit 74 selects the time lighting-pattern changed frame image such that the four sections 42A to 42D are equally allocated.

In step S82, the image synchronization unit 74 performs time synchronizations on the time lighting-pattern changed frame images on the basis of time information associated with the time lighting-pattern changed frame images of the extracted image storage unit 73. In other words, the image synchronization unit 74 selects (collects) the time lighting-pattern changed frame images captured at the same time, on the basis of the time information associated with the time lighting-pattern changed frame images. The selected time lighting-pattern changed frame images are supplied to the calibration unit 75.

In step S83, the calibration unit 75 performs calibration for calculating the external parameters of the N cameras 12 by using the time lighting-pattern changed frame images that are time-synchronized and supplied from the image synchronization unit 74. More specifically, by using time lighting-pattern changed frame images captured by the two cameras 12-A and 12-B at the same time, the calibration unit 75 sequentially performs, on the N cameras 12-1 to 12-N, processing for calculating the positional relationship between the cameras 12-A and the camera 12-B. The external parameters of the N cameras 12 are supplied to the camera parameter storage unit 76 and are stored therein, the external parameters being obtained by the calibration.

Hence, the calibration using the time lighting-pattern changed frame images, which are time-synchronized, is completed.

By the calibration of FIG. 17, the time lighting-pattern changed frame images can be selected such that the four sections 42A to 42D of the imaging region 41 are allocated in a predetermined ratio on the basis of position information associated with the time lighting-pattern changed frame images. For example, if the user carrying the calibration board 21 moves in the imaging region 41 and the cameras 12 capture images of the calibration board 21, the frame images of the sections 42 in the imaging region 41 may be unevenly distributed. Also in this case, the time lighting-pattern changed frame images of the sections 42 can be uniformly selected.

Moreover, on the basis of time information associated with the time lighting-pattern changed frame images, the plurality of time lighting-pattern changed frame images captured at the same time can be easily selected. In other words, synchronization can be easily achieved among the devices. Hence, calibration for calculating the external parameters of the cameras 12 can be performed by using the synchronized time lighting-pattern changed frame images.

The foregoing example described equal allocation in which the four sections 42A to 42D are allocated in a predetermined ratio. The sections 42A to 42D do not always need to be equally allocated. For example, if the locations of subjects serving as targets of 3D model generation are biased in the imaging region 41, the sections may be distributed according to the ratio of the locations.

<10. Modification Example of Calibration Board>

In the example of FIG. 4, the 44 light-emitting parts 23 corresponding to the information display unit 54 of the calibration board 21 are disposed in the pattern of the image pattern 22. This configuration is advantageous in that the light-emitting part 23 can be always detected by detecting the image pattern 22. In other words, in a moving image of the calibration board 21, the light-emitting parts 23 are always captured with the image pattern 22. Since the light-emitting parts 23 are located near the feature points of the image pattern 22, the light-emitting parts 23 are easily detected. The image pattern 22 may have any shape, for example, a pattern with circles in addition to a chess pattern.

The image pattern 22 is formed over a wide range in the calibration board 21, so that the multiple light-emitting parts 23 (44 in the example of FIG. 4) can be disposed in the pattern.

Since the multiple light-emitting parts 23 are provided, a sufficient amount of information can be obtained even if the information display unit 54 displays two kinds of information in the time display part 31 that illuminates according to a time and the position display part 32 that illuminates according to a position. Specifically, a large number of light-emitting parts 23 is allocated to the time display part 31 and thus the same lighting pattern does not periodically appear from the start to the end of image capturing, so that an elapsed time can be uniquely indicated. This can easily achieve synchronization among the plurality of cameras 12 that start capturing images at different times or start capturing the calibration board 21 at different times.

<Another Layout Example of Light-Emitting Parts 23>

However, the light-emitting parts 23 of the calibration board 21 do not always need to be disposed in the pattern of the image pattern 22 and may be disposed in a region other than the region of the image pattern 22.

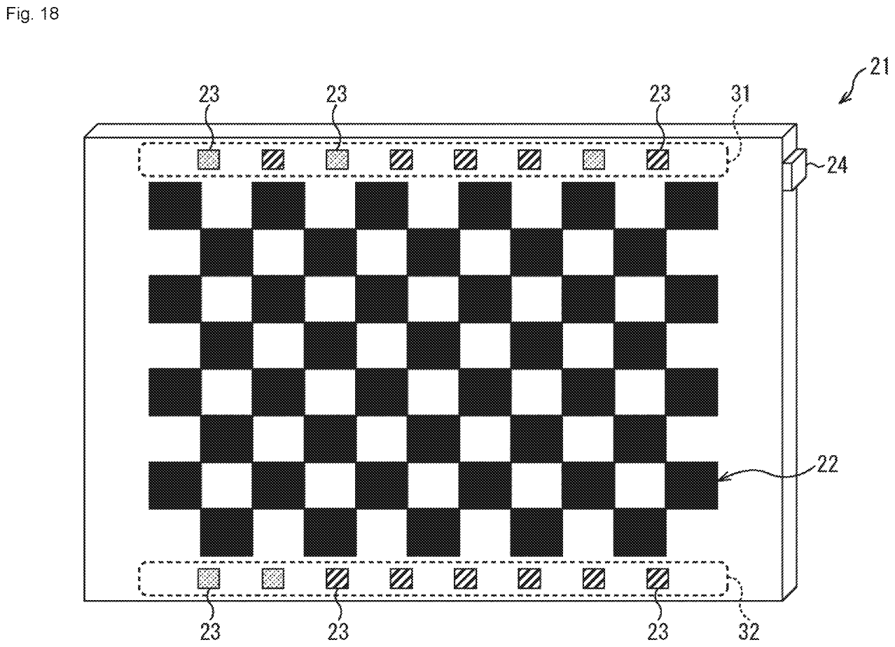

For example, as illustrated in FIG. 18, the plurality of light-emitting parts 23 constituting the time display part 31 and the plurality of light-emitting parts 23 constituting the position display part 32 may be disposed outside the region of the image pattern 22. In the example of FIG. 18, the time display part 31 and the position display part 32 are each composed of the eight light-emitting parts 23 and display position information and time information in units of 8 bits.

In addition to the time display part 31 and the position display part 32, the information display unit 54 may further include a board display part that illuminates to identify the calibration board 21 when the plurality of calibration boards 21 are used at the same time. In this case, images can be captured by using the plurality of calibration boards 21, and frame images are selected with the board display part in the same lighting condition, so that frame images including the same calibration board 21 can be selected.

<Manual Display Example of Position Display Part 32>

In the foregoing example, the calibration board 21 is provided with the position information detection unit 51 including a GPS module, and the lighting condition of the position display part 32 changes according to the detection result of the position information detection unit 51.

However, the lighting condition of the position display part 32 may be changed by a user operation on the operation button 24 serving as the operation unit 52. For example, the floor is marked with the plurality of sections 42 determined by dividing the imaging region 41, and the operation button 24 is operated according to the section 42 where a user carrying the calibration board 21 is located, so that the lighting condition can be changed according to the section 42. In this case, the position information detection unit 51 can be omitted. Moreover, the lighting condition of the position display part 32 may include an unavailable state indicating unavailability to calibration. The user operates the operation button 24 to set the lighting condition of the position display part 32 to an unavailable state during a movement between the sections 42 or at a location unavailable to calibration, so that the frame image can be excluded in the image extraction of the image extraction unit 72.

<Addition of Communication Function>

The calibration board 21 can be configured with the communication function of radio communications of Wi-Fi (registered trademark) and bluetooth (registered trademark) or cable communications. This achieves a configuration that transmits, for example, the detection result of the position information detection unit 51 to a self-propelled robot via radio communications and causes the self-propelled robot to move in the imaging region 41 according to received position information. Alternatively, the calibration board 21 transmits the detection result of the position information detection unit 51 to the smartphone (portable terminal) of the user carrying the calibration board 21, allowing the user to move in the imaging region 41 while confirming position information displayed on a map application of the smartphone. Alternatively, the detection result of the position information detection unit 51 may be transmitted to the image processing device 11 and the position of the calibration board 21 may be displayed on the display device 13, allowing the user carrying the calibration board 21 to move while confirming position information displayed on the display device 13.

<11. Configuration Example of 3D Model Generation>

When calibration for calculating the positional relationship among the cameras 12 is performed by using the moving images of the calibration board 21 imaged by the cameras 12 and the external parameters of the cameras 12 are stored in the camera parameter storage unit 76, a predetermined subject as a target of 3D model generation is prepared for imaging with the cameras 12.

3D model generation will be described below. The 3D model generation includes processing for capturing the moving images of the predetermined subject as a target of 3D model generation with the cameras 12 in the image processing system 1 and generating a 3D model of an object, which is the predetermined subject, on the basis of the moving images captured by the cameras 12, and rendering for displaying a two-dimensional image of a 3D object on the viewing device of a viewer on the basis of the generated 3D model.

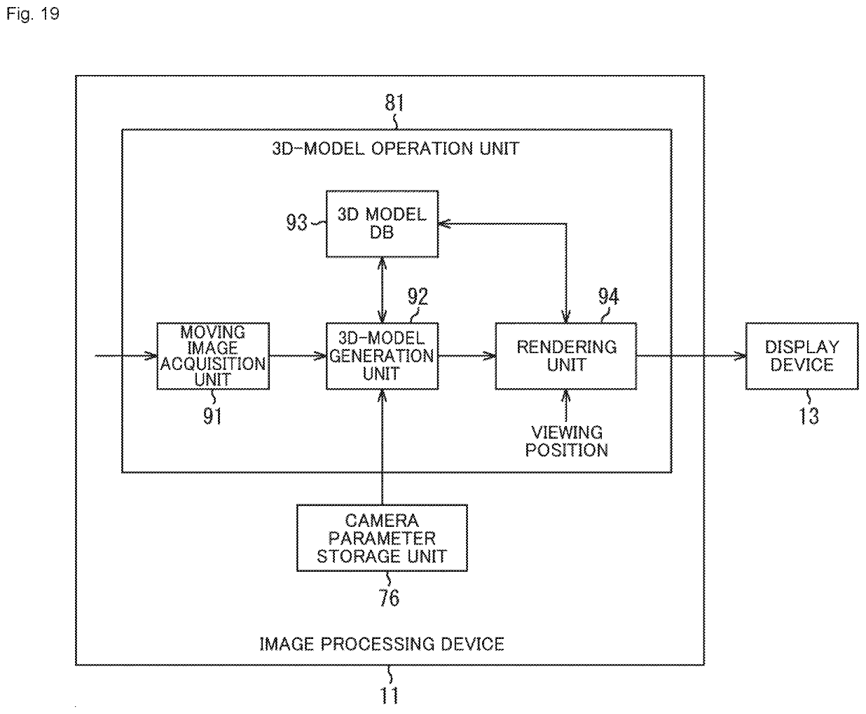

FIG. 19 is a block diagram illustrating a configuration example of 3D model generation by the image processing device 11.

The image processing device 11 includes the camera parameter storage unit 76 and a 3D-model operation unit 81. The 3D-model operation unit 81 includes a moving image acquisition unit 91, a 3D-model generation unit 92, a 3D model DB 93, and a rendering unit 94.

The moving image acquisition unit 91 acquires the images (moving images) of a subject from the N cameras 12-1 to 12-N and supplies the images to the 3D-model generation unit 92.

The 3D-model generation unit 92 acquires the camera parameters of the N cameras 12-1 to 12-N from the camera parameter storage unit 76. The camera parameters include at least an external parameter and an internal parameter.

The 3D-model generation unit 92 generates a 3D model of the subject on the basis of the images captured by the N cameras 12-1 to 12-N and the camera parameters, and stores moving image data on the generated 3D model (3D-model data) in the 3D model DB 93.

The 3D model DB 93 stores the 3D-model data generated in the 3D-model generation unit 92 and supplies the data to the rendering unit 94 in response to a request from the rendering unit 94. The 3D model DB 93 and the camera parameter storage unit 76 may be the same storage medium or different storage media.

The rendering unit 94 acquires, from the 3D model DB 93, moving image data (3D model data) on a 3D model specified by a viewer of the reproduced image of the 3D model. The rendering unit 94 then generates (reproduces) a two-dimensional image by viewing the 3D model from the viewing position of the viewer and supplies the two-dimensional image to the display device 13, the viewing position being supplied from the operation unit, which is not illustrated. On the assumption that a virtual camera is used with an imaging range equivalent to the viewing range of the viewer, the rendering unit 94 generates the two-dimensional image of the 3D object captured by the virtual camera and displays the two-dimensional image on the display device 13. The display device 13 includes the display D1 or the head-mounted display (HMD) D2 as illustrated in FIG. 1.

<12. Flowchart of 3D Model Generation>

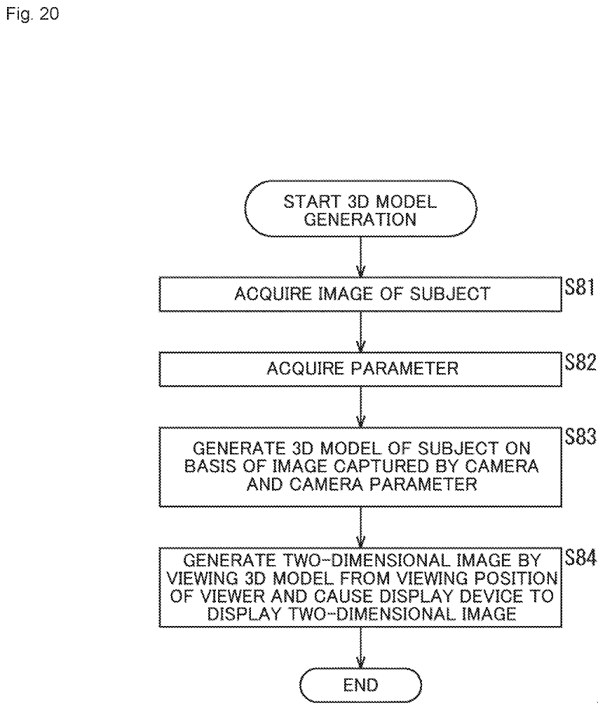

Referring to the flowchart of FIG. 20, 3D model generation by the image processing device 11 in FIG. 19 will be described below. This processing is started in response to an instruction to start processing for capturing, with the cameras 12, images of a predetermined subject serving as a target of 3D model generation in, for example, the image processing device 11.

First, in step S81, the moving image acquisition unit 91 acquires the images (moving images) of a subject from the N cameras 12-1 to 12-N and supplies the images to the 3D-model generation unit 92.

In step S82, the 3D-model generation unit 92 acquires the camera parameters of the N cameras 12-1 to 12-N from the camera parameter storage unit 76.

In step S83, the 3D-model generation unit 92 generates a 3D model of the subject on the basis of the images captured by the N cameras 12-1 to 12-N and the camera parameters, and stores moving image data on the generated 3D model (3D-model data) in the 3D model DB 93.

In step S84, the rendering unit 94 acquires, from the 3D model DB 93, moving image data (3D model data) on a 3D model specified by a viewer. The rendering unit 94 then generates (reproduces) a two-dimensional image by viewing the 3D model from the viewing position of the viewer and causes the display device 13 to display the two-dimensional image, the viewing position being supplied from the operation part, which is not illustrated.

The process of step S84 is continuously performed until the end of viewing of the reproduced image of the 3D model. When an exit operation is detected, the 3D model generation is terminated.

The 3D model generation in steps S81 to S83 and rendering for displaying a two-dimensional image of a 3D object on the viewing device of a viewer in step S84 do not have to be consecutively performed and may be performed at different timings.

As described above, the image processing device 11 can perform processing for calculating the camera parameters of the cameras 12 on the basis of the moving images of the calibration board 21, processing for generating a 3D model of an object, which is the predetermined subject, on the basis of the moving images of the predetermined subject imaged by the cameras 12 by using the calculated camera parameters, and processing for generating a two-dimensional image as a virtual viewpoint image obtained by viewing the generated 3D model of the object from a predetermined viewpoint.

<13. Computer Configuration Example>

The series of processing can be performed by hardware or software. When the series of processing is performed by software, a program constituting the software is installed in a computer. In this configuration, the computer includes a microcomputer embedded in dedicated hardware or includes, for example, a general-purpose personal computer in which various functions can be performed by installing various programs.

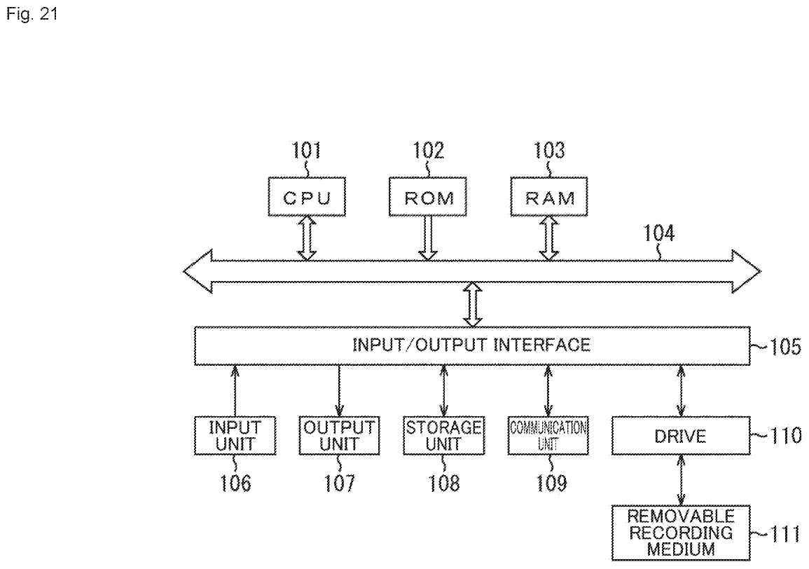

FIG. 21 is a block diagram illustrating a hardware configuration example of a computer in which the series of processing is performed by the programs.

In the computer, a CPU (Central Processing Unit) 101, a ROM (Read Only Memory) 102, and a RAM (Random Access Memory) 103 are connected to one another via a bus 104.

An input/output interface 105 is further connected to the bus 104. An input unit 106, an output unit 107, a storage unit 108, a communication unit 109, and a drive 110 are connected to the input/output interface 105.

The input unit 106 includes a keyboard, a mouse, a microphone, a touch panel, and an input terminal. The output unit 107 includes a display, a speaker, and an output terminal. The storage unit 108 includes a hard disk, a RAM disc, and a nonvolatile memory. The communication unit 109 includes a network interface. The drive 110 drives a removable recording medium 111, e.g., a magnetic disk, an optical disc, a magneto-optical disc, or a semiconductor memory.

In the computer configured thus, for example, the CPU 101 performs the series of processing by loading a program, which is stored in the storage unit 108, into the RAM 103 via the input/output interface 105 and the bus 104 and executing the program. In the RAM 103, data necessary for performing a variety of processing by the CPU 101 is also optionally stored.

The program to be executed by the computer (the CPU 101) can be recorded on, for example, the removable recording medium 111 serving as a package medium and provided in this form. The program can also be provided via wire or wireless transmission media such as a local area network, the Internet, or digital satellite broadcasting.

In the present description, the steps having been described in the flowcharts may be carried out in parallel or with necessary timing, for example, when evoked, even if the steps are not executed in time series along the order having been described therein, as well as when the steps are executed in time series.

In the present specification, a system means a collection of a plurality of constituent elements (devices, modules (components), or the like) regardless of the presence or absence of all the constituent elements in the same casing. Accordingly, a plurality of devices stored in separate casings and connected via a network and a single device including a plurality of modules stored in a casing are all systems.

Note that embodiments of the present disclosure are not limited to the foregoing embodiment and can be modified in various manners without departing from the gist of the present disclosure.

Furthermore, for example, a plurality of techniques relating to the present technique can be independently implemented as separate techniques if no contradiction arises. Of course, any present techniques may be implemented in combination. For example, at least a part of the present technique described in any one of the embodiments can be implemented in combination with at least a part of the present technique described in other embodiments. Alternatively, at least a part of the present technique can be implemented in combination with other techniques that are not described above.

For example, the present technique may be configured for cloud computing in which one function is shared and cooperatively processed by a plurality of devices via a network.

In addition, the steps described in the flowchart can be executed by a single device or can be shared among a plurality of devices.

Furthermore, if one step includes a plurality of processes, the plurality of processes included in the step can be executed by a single device or can be shared among a plurality of devices.

The advantageous effects described in the present specification are merely exemplary and are not limited, and other advantageous effects may be achieved in addition to the advantageous effects described in the present specification.

The present technique can be configured as follows:

(1)

An image processing device including: an image synchronization unit that performs time synchronization on a plurality of images of a board on a basis of lighting conditions of a plurality of light-emitting parts included in the plurality of images captured by a plurality of imaging devices, the board including the plurality of light-emitting parts and a predetermined image pattern; and a calibration unit that calculates camera parameters of the plurality of imaging devices by using the plurality of images having been subjected to the time synchronization.

(2)

The image processing device according to (1), wherein the plurality of light-emitting parts have a time display part that illuminates according to an imaging time, and the image synchronization unit performs the time synchronization on the plurality of images by selecting the images in which the time display part has the same lighting condition.

(3)

The image processing device according to (2), wherein the plurality of light-emitting parts further have a position display part that illuminates according to a position of the board, and

the image synchronization unit performs the time synchronization on the plurality of images by selecting the images in which the time display part has the same lighting condition from the images selected such that the different lighting conditions of the position display part are provided in a predetermined ratio.

(4)

The image processing device according to (3), wherein an imaging range of the plurality of imaging devices is divided into a plurality of sections, and the position display part of the plurality of light-emitting parts illuminates according to the sections.

(5)

The image processing device according to (3) or (4), wherein the image synchronization unit selects the images such that the different lighting conditions of the position display part are equally allocated.

(6)

The image processing device according to any one of (1) to (5), wherein the plurality of light-emitting parts have a board display part that illuminates to identify the board, and

the image synchronization unit performs the time synchronization on the plurality of images by selecting the images in which the board display part has the same lighting condition.

(7)

The image processing device according to any one of (1) to (6), wherein the board is configured with the light-emitting parts disposed in a pattern of the predetermined image pattern.

(8)

The image processing device according to any one of (1) to (6), wherein the board is configured with the light-emitting parts disposed in a region different from a region of the predetermined image pattern.

(9)

The image processing device according to any one of (2) to (8), wherein the time display part of the board changes the lighting condition at each lapse of a unit time.

(10)

The image processing device according to any one of (3) to (9), wherein the board further includes a position information detection unit that detects position information, and

the position display part changes the lighting condition according to a detection result of the position information detection unit.

(11)

The image processing device according to any one of (3) to (10), wherein the board further includes an operation unit that receives a user operation, and the position display part changes the lighting condition in response to an operation on the operation unit.

(12)

The imaging device according to any one of (1) to (11), wherein the light-emitting parts of the board illuminate in different colors according to 0 or 1.

(13)

The imaging processing device according to any one of (1) to (11), wherein the light-emitting parts of the board are illuminated or unilluminated according to 0 or 1.

(14)

The imaging processing device according to any one of (1) to (13), further including an extraction unit that determines whether the lighting conditions of the plurality of light-emitting parts included in the images have changed, and extracts the changed images,

wherein the image synchronization unit performs time synchronization on the plurality of images on the basis of the lighting conditions of the plurality of light-emitting parts included in the plurality of extracted images.

(15)

A calibration board including a plurality of light-emitting parts that change lighting conditions at each lapse of a unit time, and a predetermined image pattern, wherein the plurality of light-emitting parts are caused to illuminate to perform time synchronization on a plurality of images captured by a plurality of imaging devices.

(16)

A method for generating 3D model data, the method comprising: performing time synchronization on a plurality of images of a board on a basis of lighting conditions of a plurality of light-emitting parts included in the plurality of images captured by a plurality of imaging devices, the board including the plurality of light-emitting parts and a predetermined image pattern; calculating camera parameters of the plurality of imaging devices by using the plurality of images having been subjected to the time synchronization;

generating a 3D model of a predetermined subject from a plurality of subject images of the predetermined subject, the subject images being captured by the plurality of imaging device by using the calculated camera parameters; and generating a virtual viewpoint image by viewing the generated 3D model of the predetermined subject from a predetermined viewpoint.

### REFERENCE SIGNS LIST

1 Image processing system
11 Image processing device
12-1 to 12-N Camera (imaging device)
13 Display device
21 Calibration board
22 Image pattern
23 Light-emitting part
24 Operation button
31 Time display part
32 Position display part
41 Imaging region (imaging space)
42 (42A to 42D) Section
46 Common imaging range
51 Position information detection unit
52 Operation unit
53 Control unit
54 Information display unit
71 Moving image acquisition unit
72 Image extraction unit
73 Extracted image storage unit
74 Image synchronization unit
75 Calibration unit
76 Camera parameter storage unit
81 3D-model operation unit
91 Moving image acquisition unit
92 3D-model generation unit
93 3D model DB
94 Rendering unit
101 CPU
102 ROM
103 RAM
106 Input unit
107 Output unit
108 Storage unit
109 Communication unit
110 Drive

1. An image processing device comprising: an image synchronization unit that performs time synchronization on a plurality of images of a board on a basis of lighting conditions of a plurality of light-emitting parts included in the plurality of images captured by a plurality of imaging devices, the board including the plurality of light-emitting parts and a predetermined image pattern; and
a calibration unit that calculates camera parameters of the plurality of imaging devices by using the plurality of images having been subjected to the time synchronization.

2. The image processing device according to claim 1, wherein the plurality of light-emitting parts have a time display part that illuminates according to an imaging time, and
the image synchronization unit performs the time synchronization on the plurality of images by selecting the images in which the time display part has the same lighting condition.

3. The image processing device according to claim 2, wherein the plurality of light-emitting parts further have a position display part that illuminates according to a position of the board, and
the image synchronization unit performs the time synchronization on the plurality of images by selecting the images in which the time display part has the same lighting condition from the images selected such that the different lighting conditions of the position display part are provided in a predetermined ratio.

4. The image processing device according to claim 3, wherein an imaging range of the plurality of imaging devices is divided into a plurality of sections, and
the position display part of the plurality of light-emitting parts illuminates according to the sections.

5. The image processing device according to claim 3, wherein the image synchronization unit selects the images such that the different lighting conditions of the position display part are equally allocated.

6. The image processing device according to claim 1, wherein the plurality of light-emitting parts have a board display part that illuminates to identify the board, and the image synchronization unit performs the time synchronization on the plurality of images by selecting the images in which the board display part has the same lighting condition.

7. The image processing device according to claim 1, wherein the board is configured with the light-emitting parts disposed in a pattern of the predetermined image pattern.

8. The image processing device according to claim 1, wherein the board is configured with the light-emitting parts disposed in a region different from a region of the predetermined image pattern.

9. The image processing device according to claim 2, wherein the time display part of the board changes the lighting condition at each lapse of a unit time.

10. The image processing device according to claim 3, wherein the board further includes a position information detection unit that detects position information, and the position display part changes the lighting condition according to a detection result of the position information detection unit.

11. The image processing device according to claim 3, wherein the board further includes an operation unit that receives a user operation, and
the position display part changes the lighting condition in response to an operation on the operation unit.

12. The imaging device according to claim 1, wherein the light-emitting parts of the board illuminate in different colors according to 0 or 1.

13. The imaging processing device according to claim 1, wherein the light-emitting parts of the board are illuminated or unilluminated according to 0 or 1.

14. The imaging processing device according to claim 1, further comprising an extraction unit that determines whether the lighting conditions of the plurality of light-emitting parts included in the images have changed, and extracts the changed images,
wherein the image synchronization unit performs time synchronization on the plurality of images on the basis of the lighting conditions of the plurality of light-emitting parts included in the plurality of extracted images.

15. A calibration board comprising a plurality of light-emitting parts that change lighting conditions at each lapse of a unit time, and a predetermined image pattern, wherein the plurality of light-emitting parts are caused to illuminate to perform time synchronization on a plurality of images captured by a plurality of imaging devices.

16. A method for generating 3D model data, the method comprising: performing time synchronization on a plurality of images of a board on a basis of lighting conditions of a plurality of light-emitting parts included in the plurality of images captured by a plurality of imaging devices, the board including the plurality of light-emitting parts and a predetermined image pattern; calculating camera parameters of the plurality of imaging devices by using the plurality of images having been subjected to the time synchronization;
generating a 3D model of a predetermined subject from a plurality of subject images of the predetermined subject, the subject images being captured by the plurality of imaging device by using the calculated camera parameters; and generating a virtual viewpoint image by viewing the generated 3D model of the predetermined subject from a predetermined viewpoint.
